(19) United States
(12) Patent Application Publication
(10) Pub. No.: US 2017/0277394 A1
(43) Pub. Date: Sep. 28, 2017

(54) Method and Terminal for Processing Desktop Icon

(71) Applicants: Le Holdings (Beijing) Co., Ltd., Beijing (CN); Lemobile Information Technology (Beijing) Co., Ltd., Beijing (CN)

(72) Inventor: Haosen Suo, Beijing (CN)

(21) Appl. No.: 15/332,281

(22) Filed: Oct. 24, 2016

Related U.S. Application Data
(63) Continuation of application No. PCT/CN2016/096285, filed on Aug. 22, 2016.

(30) Foreign Application Priority Data
Mar. 25, 2016 (CN) 2016101803162

(51) Int. Cl. G06F 3/0481; G06F 3/0484; G06F 3/0488

(52) U.S. Cl. CPC G06F 3/04817; G06F 3/0488; G06F 3/04847; G06F 3/0482

(57) ABSTRACT

The present disclosure provides a method and terminal for processing a desktop icon. The method for processing the desktop icon according to the present disclosure includes: acquiring an operation information of a user at an edge touch area of the terminal; and incorporating a desktop icon of the terminal into a designated folder according to the user operation information at the edge touch area of the terminal. The present disclosure solves problems of high operating costs and low efficiency caused by complex desktop icon management operation in the prior art, achieves convenient and efficient processing of desktop icons, reduces the operating costs, and improves the processing efficiency.

### CROSS REFERENCE TO RELATED APPLICATIONS

This application is a continuation of International Application No. PCT/CN2016/096285, filed Aug. 22, 2016, and claims priority to Chinese Patent Application No. 2016101803162, filed Mar. 25, 2016, the disclosures of which are hereby incorporated in their entirety by reference.

### TECHNICAL FIELD

The present disclosure relates to the technical field of communications, and more particularly to a method and terminal for processing a desktop icon.

### BACKGROUND

With the development of science and technology and the improvement of technology, intelligent terminals have become more and more popular. In order to improve the use efficiency and enhance good user experience, a touch screen is used in most of the existing intelligent terminals to interact with users.

When using a terminal, a user will download and install a variety of applications according to their own needs, such as security applications of terminal, communication applications and video applications. These different applications have brought a variety of conveniences to users and enriched their leisure life.

In the process of implementing the present disclosure, the inventor found at least the following problems existing in the prior art: a variety of applications are all presented on the terminal screen in the form of desktop icons, and with the increase of the number of installed applications, there will also be a large number of desktop icons on the terminal screen. In the prior art, users need to manually operate management of each desktop icon, such as manually moving the display position of a desktop icon, or manually moving a desktop icon to a folder. Therefore, in the prior art, desktop icon management operation is relatively complex, resulting in high operating costs and low efficiency.

### SUMMARY

The present disclosure provides a method and terminal for processing desktop icon, so as to solve the problems of high operating costs and low efficiency caused by complex desktop icon management operation in the prior art.

In order to achieve the above object of the present disclosure, according to one aspect, the embodiments of the present disclosure provide a method for processing a desktop icon, executed by a terminal, and including: acquiring an operation information of a user at an edge touch area of a terminal; and incorporating a desktop icon of the terminal into a designated folder according to the operation information of the user at the edge touch area of the terminal.

According to the above-mentioned aspect and any one of possible implementation ways, an implementation way is further provided, and the operation information of a user at the edge touch area of the terminal includes: an operation information generated by a clicking operation of the user at the edge touch area of the terminal; or, an operation information generated by a pressing operation of the user at the edge touch area of the terminal; or an operation information generated by a sliding operation of the user at the edge touch area of the terminal.

According to the above-mentioned aspect and any one of possible implementation ways, an implementation way is further provided, and the edge touch area of the terminal includes an edge touch area of at least one side on the terminal.

According to the above-mentioned aspect and any one of possible implementation ways, an implementation way is further provided, and the incorporating of a desktop icon of the terminal into a designated folder according to the operation information of the user at the edge touch area of the terminal includes: determining the operation position of the user at the edge touch area of the terminal according to the operation information of the user at the edge touch area of the terminal; and incorporating at least one desktop icon corresponding to the operation position of the user at the edge touch area of the terminal into the designated folder.

According to the above-mentioned aspect and any one of possible implementation ways, an implementation way is further provided, and the incorporating of at least one desktop icon corresponding to the operation position of the user at the edge touch area of the terminal into the designated folder includes: incorporating at least one desktop icon corresponding to the operation position of the user at the edge touch area of the terminal into an existing folder on the desktop of the terminal; or, incorporating at least one desktop icon corresponding to the operation position of the user at the edge touch area of the terminal into a folder created instantly on the desktop of the terminal; and, displaying the icon and name of the folder created instantly on the desktop of the terminal.

The method for processing a desktop icon, provided by the embodiments of the present disclosure, is implemented by acquiring an operation information of a user at an edge touch area of a terminal and incorporating a desktop icon of the terminal into a designated folder according to the acquired operation information. Through processing desktop icons of a terminal by operation in an edge touch area, the embodiments of the present disclosure achieve convenient and efficient processing of desktop icons, reduce the operating costs, improve the processing efficiency, and solve the problems of high operating costs and low efficiency caused by complex desktop icon management operation in the prior art.

In order to achieve the above object of the present disclosure, according to another aspect, the embodiments of the present disclosure further provide a terminal, including: at least one processor; and a memory communicably connected with the at least one processor for storing instructions executable by the at least one processor, wherein execution of the instructions by the at least one processor causes the at least one processor to: acquire an operation information of a user at an edge touch area of a terminal; and incorporate a desktop icon of the terminal into a designated folder according to the operation information of the user at the edge touch area of the terminal.

In order to achieve the above object of the disclosure, according to another aspect, the embodiments of the present disclosure further provide a non-transitory computer-readable storage medium storing executable instructions that, when executed by an electronic device with a touch-sensitive display, cause the electronic device to: acquire an operation information of a user at an edge touch area of a terminal; and incorporate a desktop icon of the terminal into a designated folder according to the operation information of the user at the edge touch area of the terminal.

In order to achieve the above object of the disclosure, according to a next aspect, the embodiments of the present disclosure further provide a computer program product, including a computer program stored in a non-transient computer-readable storage medium, wherein the computer program includes program instructions that, when executed by a computer, enable the computer to executes the method mentioned by the above aspects.

The terminal, storage medium and computer program, provided by the embodiments of the present disclosure, is implemented by acquiring an operation information of a user at an edge touch area of a terminal and incorporating a desktop icon of the terminal into a designated folder according to the acquired operation information. Through processing a desktop icon of a terminal by operation at an edge touch area, the embodiments of the present disclosure achieve convenient and efficient processing of desktop icons, reduce the operating costs, improve the processing efficiency, and solve the problems of high operating costs and low efficiency caused by complex desktop icon management operation in the prior art.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart in accordance with embodiment 1 of the method for processing a desktop icon provided by embodiments of the present disclosure;

FIG. 2 is a flow chart in accordance with embodiment 2 of the method for processing a desktop icon provided by embodiments of the present disclosure;

FIG. 3 is a schematic diagram of a first structure of the terminal provided by embodiments of the present disclosure;

FIG. 4 is a schematic diagram of a second structure of the terminal provided by embodiments of the present disclosure; and

FIG. 5 is a schematic diagram of a hardware structure of the terminal executing the method for processing desktop icon provided by embodiments of the present disclosure.

### DETAILED DESCRIPTION

The preferred embodiments of the present disclosure are illustrated hereinafter with reference to the appended drawings, and it will be appreciated that the preferred embodiments described herein are only described to illustrate and explain the present disclosure, and are not intended to limit the present disclosure.

It shall be clear that only parts of the embodiments, instead of all embodiments, of the present disclosure are described. Based on the embodiments of the present disclosure, all other embodiments concluded by those skilled in the art without making inventive labor fall within the protection scope of the present disclosure.

As used in the embodiments of the present disclosure, the terms are intended to describe specific embodiments only, not to limit the present disclosure. The singular forms of “a”, “said” and “the” used in the embodiments and appended claims of the present disclosure are also intended to include plural forms, unless the context expressly indicates other meanings.

Depending on the context, as used herein, the word “if” can be interpreted as “at the time of . . . ” or “when . . . ” or “in response to determination” or “in response to detection”. Similarly, depending on the context, the phrase “if it is determined” or “if it is detected (stated conditions or events)” may be interpreted as “when determining” or “in response to determination” or “when detecting (stated conditions or events)” or “in response to detection (stated conditions or events)”.

### Embodiment 1

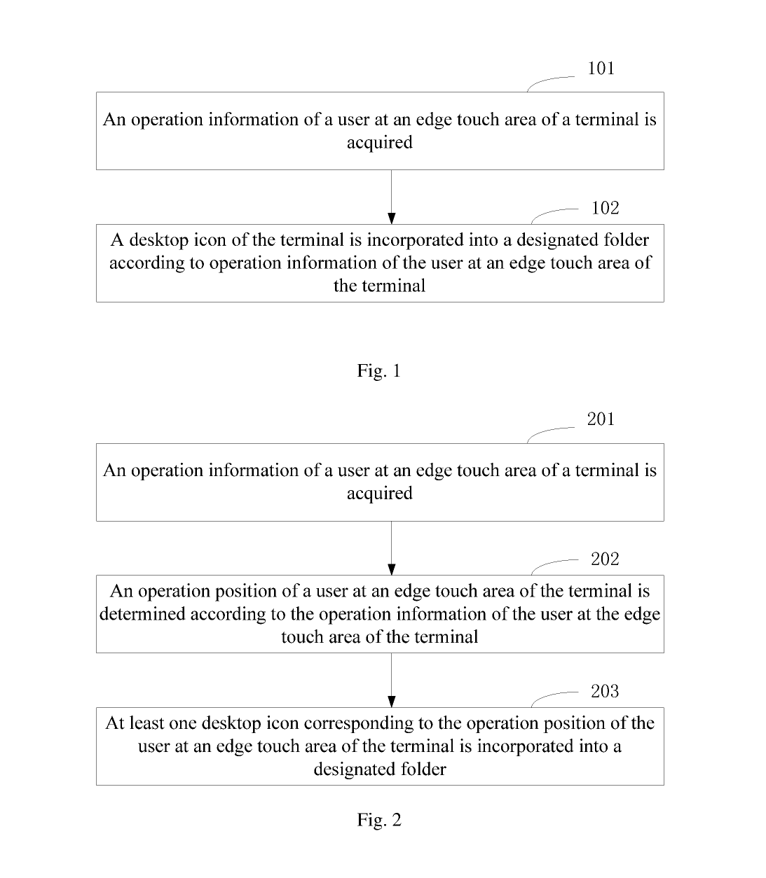

FIG. 1 is a flow chart in accordance with embodiment 1 of the method for processing desktop icons provided by embodiments of the present disclosure. As shown in FIG. 1, the method for processing a desktop icon according to the embodiment is executed by a terminal. The method may specifically include the following steps 101-102.

101: An operation information of a user at an edge touch area of a terminal is acquired.

In the process of using a terminal, a user often downloads and installs some applications as needed. However, in a prior art, after a terminal downloads and installs multiple applications, desktop icons will be increased accordingly, and the number of desktop pages of the terminal will be increased with the increase of the number of applications, e.g., page 1, page 2, page 3, etc. When page 1 is full of desktop icons, newly installed applications will be displayed on page 2. Because users often randomly downloads applications, when a user needs to use an application, the user needs to turn the pages several times to find the application, which may cause a complicated operation.

In view of this, the user will select to arrange and sort out a plurality of desktop icons on a desktop of a terminal. The desktop icons of one category are placed together or put in one folder, so as to find them conveniently and efficiently. For example, a plurality of video desktop icons are placed in a folder named video, the payment desktop icons are placed in a folder named payment, etc.

Therefore, the embodiment provides a solution, in order to provide users with a method for conveniently and efficiently processing desktop icon and improve users' efficiency of arrangement and classification.

It shall be noted that, the terminal involved in the embodiments of the present disclosure may include, but is not limited to, a personal computer (PC), a personal digital assistant (PDA), a wireless handheld device, a tablet computer, a mobile phone, a MP3 player, a MP4 player, etc., and the terminal has a screen.

According to the embodiments of the present disclosure, an operation information of a user at an edge touch area of a terminal may include, but is not limited to: an operation information generated by a sliding operation of a user at an edge touch area of the terminal; or, an operation information generated by a clicking operation of a user at an edge touch area of the terminal; or, an operation information generated by a pressing operation of a user at an edge touch area of the terminal.

It will be appreciated that, the edge touch means providing touch input through a terminal edge, side frame or back surface to track the clicking, sliding or pressing operation of a finger on the edge of the terminal, so as to achieve terminal control.

The edge touch area of a terminal may be an area on a side surface of the terminal accessible to a user's thumb when the user naturally holds the terminal, and the side surface of the terminal may include other four side surface except the front surface and the back surface.

According to the embodiment of the present disclosure, an edge touch area of a terminal may be implemented using physical keys, virtual keys, sensors or screens, etc.

According to the embodiment of the present disclosure, the edge touch area includes the edge touch area on at least one side surface of the terminal.

For example, if a terminal uses a curved screen, the edge touch area of the terminal can be implemented using the edge screen of the curved screen. Illustrated by taking a capacitive touch screen as an example, when a user's finger touches the edge touch screen, the capacitance of electric shock will change, so that the frequency of an oscillator connected with the capacitor changes, the touch position can be determined by measuring the frequency change of the oscillator, and then an operation information of a user at the edge touch area of the terminal can be acquired.

For another example, if there are physical keys for volume adjustment on the edge of a terminal, description is provided with physical keys for volume adjustment on the terminal as an example: when a user's finger presses a physical key for volume adjustment, the terminal will know the user presses a volume up key or a volume down key. Similarly, when a user presses the edge touch area, the terminal can acquire the operation information of a user at the edge touch area of the terminal.

For another example, if there are virtual keys with certain functions on the edge of a terminal and the virtual keys are capacitive virtual keys, the terminal determines which virtual key is touched by a user through the capacitance of the capacitive virtual key. Specifically, when a user touches a capacitive virtual key, the finger will form a capacitor together with an electrode slice in the capacitive virtual key, and the terminal determines the user touch position by detecting the capacitance change, thereby determining which virtual key is touched by the user, and then acquiring the user operation information at the edge touch area of the terminal.

For another example, in the case that there are sensors having certain functions on the edge of a terminal, for example, there are pressure sensors, when a user presses a pressure sensor, a semiconductor deformation pressure is formed on the surface of a pressure sensor sheet, and the sheet is pressed to deform so as to generate a piezoelectric impedance effect, so that the impedance change is converted into an electrical signal. After acquiring the electrical signal, the terminal can determine which pressure sensor or which position on the pressure sensor is pressed by the user, so as to determine the pressure sensor with which function pressed by the user, and then acquire the user operation information at the edge touch area of the terminal. In addition, sensors with certain functions on the edge of a terminal may also be light sensors.

According to the embodiment of the present disclosure, a terminal detects the sliding, clicking or pressing operation of a user by the edge touch area to acquire corresponding operation information.

102: A desktop icon of the terminal is incorporated into a designated folder according to operation information of the user at an edge touch area of the terminal.

After a user performs a certain operation at an edge touch area of a terminal, the terminal acquires corresponding operation information, and incorporates a desktop icon of the terminal into a designated folder according to the operation information of a user at the edge touch area of the terminal.

For example, an edge touch area on the left side of a terminal is used for controlling desktop icons in a row and incorporating them into a folder.

Specifically, the user operation at an edge touch area of the terminal may be a pressing operation. If there are two physical keys on the left side of a terminal, when a user's finger presses the two physical keys, the terminal can acquire the operation information of the user at an edge touch area of the terminal. When the user presses the upper physical key of the two physical keys on the terminal screen, the desktop icons in a raw corresponding to the physical key are incorporated into a folder.

For another example, an edge touch area at the upper side of a terminal is used for controlling desktop icons in a line and incorporating them into a folder.

Specifically, the user operation at an edge touch area of the terminal may also be a clicking operation. If there are virtual keys with certain functions at the top of a terminal, and the virtual keys are capacitive virtual keys, the user performs clicking operation on a virtual key of the terminal with his finger, then the terminal determines which virtual key is clicked on by the user according to the capacitance of the capacitive virtual key, and can acquire the operation information of the user at the edge touch area of the terminal. When a user clicks on a virtual key corresponding to one position on the terminal screen, the desktop icons in a line corresponding to the virtual key are incorporated into a folder.

For another example, an edge touch area on the right side of a terminal is used for controlling desktop icons in two rows and incorporating them into a folder.

Specifically, the control can be implemented by a sliding operation at the edge touch area. If a terminal uses a curved screen, the edge touch area of the terminal can be realized using the edge screen of the curved screen. Illustrated by taking a capacitive touch screen as an example, a user performs a sliding operation at an edge touch area on the right side of a terminal by his index finger, wherein the sliding operation may be sliding up, and may also be sliding down. When a user's finger slides up, the terminal determines the sliding direction of the user's index finger by detecting the capacitance change, so as to determine that the user's index finger is sliding up, and control the desktop icons in two rows on the terminal corresponding to the sliding direction and distance to be incorporated into a folder according to the up sliding direction and distance.

The method for processing a desktop icon provided by the embodiment of the present disclosure is implemented by acquiring an operation information of a user at an edge touch area of the terminal and incorporating a desktop icon of a terminal into a designated folder according to the acquired operation information. Through processing desktop icons of a terminal by operation at an edge touch area, the embodiment of the present disclosure achieves convenient and efficient processing of desktop icons, reduces the operating costs, improves the processing efficiency, and solves the problems of high operating costs and low efficiency caused by complex desktop icon management operation in the prior art.

### Embodiment 2

FIG. 2 is a flow chart in accordance with embodiment 2 of the method for processing desktop icons provided by embodiments of the present disclosure. As shown in FIG. 2, the method for processing a desktop icon according to the embodiment may specifically include the steps 201-203 as follows.

201: An operation information of a user at an edge touch area of a terminal is acquired.

Details of the process of acquiring operation information of a user at an edge touch area of the terminal are provided in step 101 of the above embodiment. The principle and implementation process in the embodiment of the present disclosure are the same, and will not be repeated herein.

202: An operation position of a user at an edge touch area of the terminal is determined according to the operation information of the user at the edge touch area of the terminal.

After a user performs a certain operation at an edge touch area of a terminal, the terminal acquires corresponding operation information, and determines operation position of the user at the edge touch area of the terminal according to the operation information of the user at the edge touch area of the terminal.

For example, physical keys are set at an edge touch area of a terminal and user's operation at the edge touch area of the terminal may be a pressing operation. If there are two physical keys on the left side of the terminal, when a user's finger presses the two physical keys, the terminal can acquire the operation information of the user at the edge touch area of the terminal. When a user presses the upper physical key of the two physical keys, the terminal determines that the operation position of the user at an edge touch area of the terminal is the upper physical key of the two physical keys.

For another example, certain virtual keys are set at an edge touch area of a terminal, and user's operation at the edge touch area of the terminal may also be a clicking operation. If there are virtual keys with certain functions at the top of the terminal, and the virtual keys are capacitive virtual keys, a user performs a clicking operation on a virtual key of the terminal by his finger, then the terminal determines which virtual key is clicked on by the user according to the capacitance of the capacitive virtual key, and can acquire the operation information of the user at the edge touch area of the terminal. When a user clicks on one of the virtual keys, the terminal determines that the operation position of a user at an edge touch area of the terminal is one of the virtual keys.

For another example, if a terminal use a curved screen, the user operation at an edge touch area of the terminal may also be a sliding operation. If a terminal uses a curved screen, the edge touch area of the terminal can be realized using the edge screen of the curved screen. Illustrated with a capacitive touch screen as an example, a user performs a sliding operation at an edge touch area on the right side of the terminal by his index finger, wherein the sliding operation may be sliding up, and may also be sliding down. When the user's finger slides up, the terminal determines the sliding direction of the user's index finger by detecting the capacitance change, so as to determine that the user's index finger is sliding up, and determine that the operation position of the user at an edge touch area of the terminal is a certain area, according to the sliding direction and distance.

203: At least one desktop icon corresponding to the operation position of the user at an edge touch area of the terminal is incorporated into a designated folder.

When a user operates at an edge touch area of the terminal, desktop icons corresponding to the operation position may be desktop icons in a row, may also be desktop icons in a line, and may also be an icon in the same row with a folder. The incorporating the desktop icons at the operation position into a designated folder may specifically include the following operations:
at least one desktop icon corresponding to the operation position of the user at an edge touch area of the terminal is incorporated into an existing folder on a desktop of the terminal; or,
at least one desktop icon corresponding to the operation position of the user at an edge touch area of the terminal is incorporated into a folder created instantly on the desktop of the terminal; and, the icon and name of the folder created instantly are displayed on the desktop of the terminal.

For example, physical keys are set at an edge touch area of the terminal. If there are two physical keys on the left side of the terminal, and when a user presses the upper physical key of the two physical keys, the terminal determines that operation position of the user at the edge touch area of the terminal is the upper physical key of the two physical keys, two desktop icons correspond to the physical key, the two desktop icons are incorporated into a folder created instantly on the desktop of the terminal, and the icon and name of the folder created instantly are displayed on the desktop of the terminal.

For another example, certain virtual keys are set at an edge touch area of the terminal. If there are virtual keys with certain functions at the top of the terminal, and the virtual keys are capacitive virtual keys, a user performs a clicking operation on a virtual key of the terminal by his finger, then the terminal can acquire that the user clicks on one of the virtual keys at the edge touch area of the terminal, determine that the operation position of the user at the edge touch area of the terminal is one of the virtual keys, which corresponds to a desktop icon and a folder, and then incorporate the desktop icon into the folder.

It will be appreciated that, the application may be a native App installed on a terminal, or may also be a web App of a browser on the terminal, which is not limited by the embodiment of the present disclosure.

The method for processing a desktop icon provided by the embodiment of the present disclosure is implemented by acquiring an operation information of a user at an edge touch area of the terminal, and incorporating a desktop icon of the terminal into a designated folder according to the acquired operation information. Through processing desktop icons of the terminal by operation at an edge touch area, the embodiment of the present disclosure achieves convenient and efficient processing of desktop icons, reduces the operating costs, improves the processing efficiency, and solves the problems of high operating costs and low efficiency caused by complex desktop icon management operation in the prior art.

### Embodiment 3

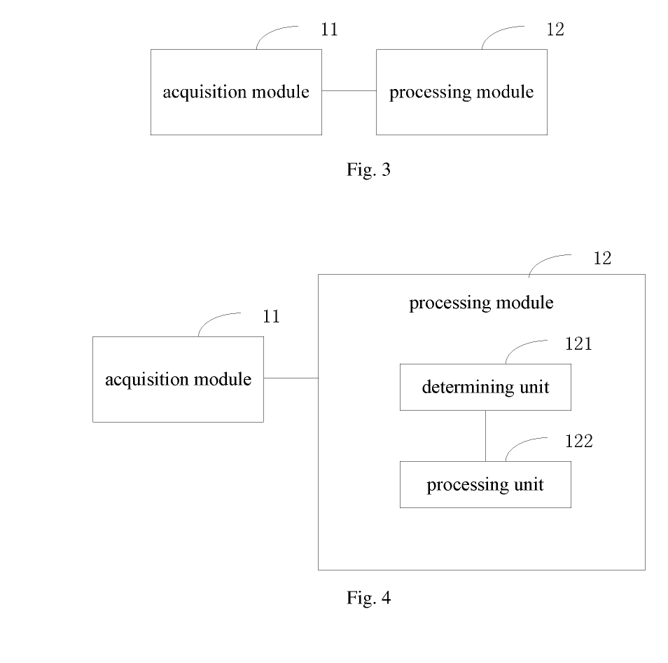

FIG. 3 is a schematic diagram of a first structure of the terminal provided by an embodiment of the present disclosure. As shown in FIG. 3, the terminal provided by the embodiment of the present disclosure includes an acquisition module 11 and a processing module 12.

The acquisition module 11 is used for acquiring an operation information of a user at an edge touch area of the terminal.

The processing module 12 is used for incorporating a desktop icon of the terminal into a designated folder according to the operation information of the user at the edge touch area of the terminal.

Wherein, the user operation information at the edge touch area of the terminal includes: operation information generated by a sliding operation of the user at the edge touch area of the terminal; or, operation information generated by a clicking operation of the user at the edge touch area of the terminal; or, operation information generated by a pressing operation of the user at the edge touch area of the terminal.

It shall be noted that the edge touch area of the terminal in this embodiment includes the edge touch area on at least one side of the terminal.

All modules in the embodiment are capable of executing the method shown in FIG. 1. Please refer to relevant description of FIG. 1 for the parts that are not described in detail in the embodiment.

The terminal according to the embodiment of the present disclosure acquires user operation information at an edge touch area of the terminal by the acquisition module 11 and incorporates desktop icons of the terminal into a specified folder by the processing module 12 according to the acquired operation information. Through processing desktop icons of the terminal by operation at an edge touch area, the embodiment of the present disclosure achieves convenient and efficient processing of desktop icons, reduces the operating costs, improves the processing efficiency, and solves the problems of high operating costs and low efficiency caused by complex desktop icon management operation in the prior art.

### Embodiment 4

FIG. 4 is a schematic diagram of a second structure of the terminal provided by an embodiment of the present disclosure. As shown in FIG. 4, on the basis of the above embodiments, the terminal provided by the embodiment of the present disclosure further includes a processing module 12, which includes a determining unit 121 and a processing unit 122.

The determining unit 121 is used for determining the operation position of the user at an edge touch area of the terminal according to the operation information of the user at the edge touch area of the terminal.

The processing unit 122 is used for incorporating at least one desktop icon corresponding to the operation position of the user at an edge touch area of the terminal into a designated folder.

Wherein the processing unit 122 is specifically used for: incorporating at least one desktop icon corresponding to the operation position of the user at an edge touch area of the terminal into an existing folder on a desktop of the terminal; or, incorporating at least one desktop icon corresponding to the operation position of a user at the edge touch area of the terminal into a folder created instantly on the desktop of the terminal, and displaying the icon and name of the folder created instantly on the desktop of the terminal.

All modules in the embodiment are capable of executing the method shown in FIG. 2. Please refer to relevant description of FIG. 2 for the parts that are not described in detail in the embodiment.

The terminal according to the embodiment of the present disclosure acquires the user operation information at an edge touch area of the terminal by the acquisition module 11, determines the user operation position at the edge touch area of the terminal by the determining unit 121 of the processing module 12, and incorporates at least one desktop icon corresponding to the position into a specified folder by the processing unit 122 according to the position determined by the determining unit 121, thereby achieving convenient and efficient processing of desktop icons, reducing the operating costs, improving the processing efficiency, and solving the problems of high operating costs and low efficiency caused by complex desktop icon management operation in the prior art. It will be appreciated by those skilled in the art that: all or parts of the steps to achieve various embodiments of the methods mentioned above can be completed by hardware related to program instructions. The preceding programs may be stored in a computer-readable storage medium. Execution of the program includes the steps in various embodiments of the methods mentioned above; and the aforementioned storage medium includes: various media that can store program codes, e.g. an ROM, an RAM, a disk, a CD, and the like.

The embodiments of the devices described above are described by way of example only, wherein the units described as separate components may be or may also not be physically separated, and the components shown as units may be or may also not be physical units, i.e., may be located in one place, or may also be distributed to at least two network units. According to actual needs, parts or all of the modules therein are selected to achieve the object of the solution of this embodiment. Those skilled in the art can understand and implement the embodiments without making any inventive labor.

Finally, it shall be noted that: the above embodiments are only used for explaining the technical solutions of the present disclosure, rather than limiting them. The present disclosure is described in detail with reference to the preceding embodiments, but those skilled in the art shall understand that: they can still modify the technical solutions according to various preceding embodiments, or equivalently substitute parts or all of the technical features thereof; and these modifications or substitutes do not cause the essence of corresponding technical solutions to depart from the scope of the technical solutions according to the embodiments of the present disclosure.

### Embodiment 5

The embodiment of the present disclosure provides a non-volatile computer storage medium storing computer-executable instructions that can execute the processing method in the embodiments of any one of the above methods.

### Embodiment 6

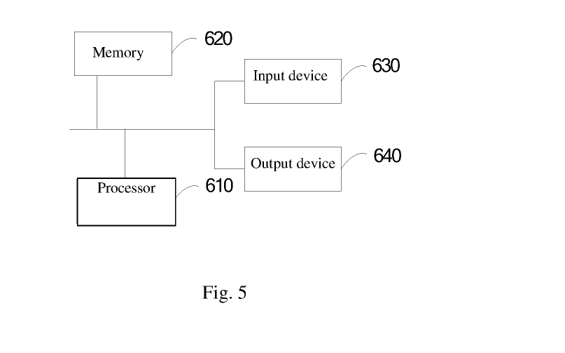

FIG. 5 is a schematic diagram of the hardware structure of the terminal executing the method for processing a desktop icon, provided by an embodiment of the present disclosure. As shown in FIG. 5, the terminal includes:
one or more processors 610 and a memory 620. FIG. 5 takes one processor 610 as an example. The terminal may further include: an input device 630 and an output device 640.

The processor 610, the memory 620, the input device 630 and the output device 640 can be connected with a bus or by other means. FIG. 5 takes bus connection as an example.

As a non-volatile computer-readable storage medium, the memory 620 can be used for storing non-volatile software programs, non-volatile computer-executable programs and modules. The processor 610 runs non-volatile software programs, instructions and modules stored in the memory 620, so as to execute various function applications and data processing of a server, i.e., implementing the processing method in the embodiments of the above methods.

The memory 620 may include a program storage area and a data storage area, wherein the program storage area may store an operating system and applications required by at least one function; the data storage area may store data, etc. In addition, the memory 620 may include a high-speed random access memory, and may further include a non-volatile memory, such as at least one disk memory device, a flash memory device, or other non-volatile solid-state memory device. In some embodiments, the memory 620 may optionally include remote memories relative to the processor 610, and these remote memories can be connected to the processing unit over a network. Examples of the above network include, but are not limited to the Internet, intranets, LANs, mobile communication networks and combinations thereof.

The input device 630 receives input numerical or character information, and generates a signal input. The output device 640 may include a display screen and other display devices.

The one or more modules are stored in the memory 620, and execute, when executed by the one or more processors 610: acquiring the operation information of a user at an edge touch area of the terminal; and incorporating a desktop icon of the terminal into a designated folder according to the user operation information at the edge touch area of the terminal.

According to a possible implementation way, the operation information of the user at an edge touch area of the terminal includes: an operation information generated by a clicking operation of the user at the edge touch area of the terminal; or, an operation information generated by a pressing operation of the user at the edge touch area of the terminal; or, an operation information generated by a sliding operation of the user at the edge touch area of the terminal.

According to a possible implementation way, the edge touch area of the terminal includes the edge touch area on at least one side of the terminal.

According to a possible implementation way, the incorporating a desktop icon of the terminal into a designated folder according to the user operation information at an edge touch area of the terminal includes: determining the operation position of the user at the edge touch area of the terminal according to the operation information of the user at the edge touch area of the terminal; and incorporating at least one desktop icon corresponding to the operation position of the user at the edge touch area of the terminal into a designated folder.

According to a possible implementation way, the incorporating at least one desktop icon corresponding to the operation position of the user at an edge touch area of the terminal into a designated folder includes: incorporating at least one desktop icon corresponding to the operation position of the user at the edge touch area of the terminal into an existing folder on a desktop of the terminal; or incorporating at least one desktop icon corresponding to the operation position of the user at the edge touch area of the terminal into a folder created instantly on the desktop of the terminal, and displaying the icon and name of the folder created instantly on the desktop of the terminal.

The above product can execute the method according to the embodiments of the present disclosure, and has corresponding function modules for performing the method and beneficial effects. About the technical details that are not described in detail in this embodiment, please refer to the method according to the embodiments of the present disclosure.

The electronic device according to the embodiments of the present disclosure exists in a variety of forms, including but not limited to:

Mobile communication equipment: such equipment is featured with its mobile communication function, and mainly aims to provide voice and data communication. Such terminals include: smartphones (such as iPhone), multimedia mobile phones, functional mobile phones, low-end mobile phones, etc.

Ultra-mobile PC equipment: such equipment belongs to the category of PC, has calculating and processing functions, and usually also has mobile Internet features. Such terminals include: PDA, MID, UMPC devices, etc., e.g. iPad.

Portable entertainment equipment: such equipment can display and play multimedia contents and includes: audio, video players (such as iPad), handheld game players, e-books, smart toys and portable vehicle navigation devices.

Servers: equipment providing computing service. The server components include a processor, hard drives, an internal memory, a system bus, etc. The servers are similar to a general computer in term of architecture. But because the servers need to provide highly reliable service, the requirements on processing capacity, stability, reliability, security, scalability, manageability, etc. are very high.

Other electronic devices having data interaction functions.

The embodiments of the devices described above are presented by way of example only, wherein the units described as separate components may be or may also not be physically separated, and the components shown as units may be or may also not be physical units, i.e., may be located in one place, or may also be distributed to a plurality of network units. According to actual needs, parts or all of the modules therein are selected to achieve the object of the solution of this embodiment.

Through the description of the above implementation way, those skilled in the art can clearly understand that various embodiments may be realized using software and a universal hardware platform, and of course, may also be realized by hardware. Based on such understanding, the above technical solution may be essentially reflected or the parts thereof making contribution to related technology may be reflected in the form of software products. The computer software products can be stored in the computer readable storage medium, e.g. an ROM/RAM, a disk, a CD, and the like, including a number of instructions for causing a computer device (a PC, a server, or a network device, etc.) to execute the methods according to the embodiments or some parts of the embodiments.

Finally, it shall be noted that the above embodiments are only used for explaining the technical solutions of the present disclosure, rather than limiting them. The present disclosure is described in detail with reference to the preceding embodiments, but those skilled in the art shall understand that: they can still modify the technical solutions according to various preceding embodiments, or equivalently substitute parts of the technical features thereof; and these modifications or substitutes do not cause the essence of corresponding technical solutions to depart from the spirit and scope of the technical solutions according to the embodiments of the present disclosure.

What is claimed is:

1. A method for processing a desktop icon, comprising:
acquiring an operation information of a user at an edge touch area of a terminal; and
incorporating a desktop icon of the terminal into a designated folder according to the operation information of the user at the edge touch area of the terminal.

2. The method according to claim 1, wherein the operation information of a user at the edge touch area of the terminal comprises:
an operation information generated by a clicking operation of the user at the edge touch area of the terminal; or,
an operation information generated by a pressing operation of the user at the edge touch area of the terminal; or
an operation information generated by a sliding operation of the user at the edge touch area of the terminal.

3. The method according to claim 1, wherein the edge touch area of the terminal includes an edge touch area of at least one side on the terminal.

4. The method according to claim 1, wherein the incorporating a desktop icon of the terminal into a designated folder according to the operation information of the user at the edge touch area of the terminal comprises:
determining the operation position of the user at the edge touch area of the terminal according to the operation information of the user at the edge touch area of the terminal; and
incorporating at least one desktop icon corresponding to the operation position of the user at the edge touch area of the terminal into the designated folder.

5. The method according to claim 4, wherein the incorporating at least one desktop icon corresponding to the operation position of the user at the edge touch area of the terminal into the designated folder comprises:
incorporating at least one desktop icon corresponding to the operation position of the user at the edge touch area of the terminal into an existing folder on the desktop of the terminal; or,
incorporating at least one desktop icon corresponding to the operation position of the user at the edge touch area of the terminal into a folder created instantly on the desktop of the terminal;
and, displaying the icon and name of the folder created instantly on the desktop of the terminal.

6. A terminal, comprising:
at least one processor; and
a memory communicably connected with the at least one processor for storing instructions executable by the at least one processor, wherein execution of the instructions by the at least one processor causes the at least one processor to:
acquire an operation information of a user at an edge touch area of a terminal; and
incorporate a desktop icon of the terminal into a designated folder according to the operation information of the user at the edge touch area of the terminal.

7. The terminal according to claim 6, wherein the operation information of a user at the edge touch area of the terminal comprises:
an operation information generated by a clicking operation of the user at the edge touch area of the terminal; or,
an operation information generated by a pressing operation of the user at the edge touch area of the terminal; or
an operation information generated by a sliding operation of the user at the edge touch area of the terminal.

8. The terminal according to claim 6, wherein the edge touch area of the terminal comprises an edge touch area of at least one side on the terminal.

9. The terminal according to claim 6, wherein execution of the instructions by the at least one processor causes the at least one processor to:
determine the operation position of the user at the edge touch area of the terminal according to the operation information of the user at the edge touch area of the terminal; and
incorporate at least one desktop icon corresponding to the operation position of the user at the edge touch area of the terminal into the designated folder.

10. The terminal according to claim 9, wherein execution of the instructions by the at least one processor causes the at least one processor to:
incorporate at least one desktop icon corresponding to the operation position of the user at the edge touch area of the terminal into an existing folder on the desktop of the terminal; or,
incorporate at least one desktop icon corresponding to the operation position of the user at the edge touch area of the terminal into a folder created instantly on the desktop of the terminal;
and, displaying the icon and name of the folder created instantly on the desktop of the terminal.

11. A non-transitory computer-readable storage medium storing executable instructions that, when executed by an electronic device with a touch-sensitive display, cause the electronic device to:
acquire an operation information of a user at an edge touch area of a terminal; and
incorporate a desktop icon of the terminal into a designated folder according to the operation information of the user at the edge touch area of the terminal.

12. The non-transitory computer-readable storage medium according to claim 11, wherein the operation information of a user at the edge touch area of the terminal comprises:
an operation information generated by a clicking operation of the user at the edge touch area of the terminal; or,
an operation information generated by a pressing operation of the user at the edge touch area of the terminal; or
an operation information generated by a sliding operation of the user at the edge touch area of the terminal.

13. The non-transitory computer-readable storage medium according to claim 11, wherein the edge touch area of the terminal comprises an edge touch area of at least one side on the terminal.

14. The non-transitory computer-readable storage medium according to claim 11, wherein the incorporating a desktop icon of the terminal into a designated folder according to the operation information of the user at the edge touch area of the terminal comprises:
determining the operation position of the user at the edge touch area of the terminal according to the operation information of the user at the edge touch area of the terminal; and
incorporating at least one desktop icon corresponding to the operation position of the user at the edge touch area of the terminal into the designated folder.

15. The non-transitory computer-readable storage medium according to claim 14, wherein the incorporating at least one desktop icon corresponding to the operation position of the user at the edge touch area of the terminal into the designated folder comprises:
incorporating at least one desktop icon corresponding to the operation position of the user at the edge touch area of the terminal into an existing folder on the desktop of the terminal; or,
incorporating at least one desktop icon corresponding to the operation position of the user at the edge touch area of the terminal into a folder created instantly on the desktop of the terminal;
and, displaying the icon and name of the folder created instantly on the desktop of the terminal.
